(19) United States
(12) Patent Application Publication
(10) Pub. No.: US 2015/0178453 A1
(43) Pub. Date: Jun. 25, 2015

(54) Systems and Methods for Core Measures

(71) Applicant: Dolbey Systems, Inc., Concord, OH (US)

(72) Inventors: Kris Wilson, Estero, FL (US); Robert Sintic, Leroy, OH (US); Michael Lambert, Painesville, OH (US)

(73) Assignee: DOLBEY SYSTEMS, INC., Concord, OH (US)

(21) Appl. No.: 14/566,284

(22) Filed: Dec. 10, 2014

Related U.S. Application Data
(60) Provisional application No. 61/918,820, filed on Dec. 20, 2013.

(51) Int. Cl. G06F 19/00

(52) U.S. Cl. CPC G06F 19/327; G06F 19/363

(57) ABSTRACT

Included are systems and methods for providing core measures. One embodiment of a method includes receiving patient information regarding a patient, where the patient information includes data related to a treatment for the patient that was performed at a treatment facility, determining whether at least a portion of the patient information is related to a measure that is defined by a compliance agency, where the measure establishes a benchmark for quality regarding the treatment, and in response to determining that a least a portion of the patient information is related to the measure, categorizing the portion into the measure. Some embodiments include providing a question to a user wherein the question is associated with the measure and the treatment, receiving an answer to the question, and determining from the answer whether the treatment meets the benchmark of the measure.

### CROSS REFERENCE

This application claims the benefit of U.S. Provisional Application Ser. No. 61/918,820 filed Dec. 20, 2013, which is hereby incorporated by reference in its entirety.

### BACKGROUND

1. Field

Embodiments provided herein generally relate providing core measures, and particularly to providing a computing platform for medical care compliance.

2. Technical Background

Treatment facilities, such as hospitals, emergency rooms, medical offices, etc. are oftentimes required to comply with predetermined care guidelines that are set forth by government agencies and other entities. As an example, the center for Medicare and Medicaid services (CMMS), the Joint Commission for ensuring compliance, and/or other similar organizations may determine treatment facility compliance, as well as provide treatment facility certification and funding. Accordingly, these compliance services may set forth certain guidelines with which the treatment facilities must comply in order to maintain current certifications, payments, etc. As an example, the guidelines may include predetermined standard diagnosis steps, treatment steps, etc. to ensure that patients are getting a threshold level of care. Accordingly, many current solutions involve the treatment facility staff creating and populating various reports to be mailed to the various agencies. Thus a need exists in the industry.

### SUMMARY

Included are systems and methods for providing core measures. One embodiment of a method includes receiving patient information regarding a patient, where the patient information includes data related to a treatment for the patient that was performed at a treatment facility, determining whether at least a portion of the patient information is related to a measure that is defined by a compliance agency, where the measure establishes a benchmark for quality regarding the treatment, and in response to determining that a least a portion of the patient information is related to the measure, categorizing the portion into the measure. Some embodiments include providing a question to a user where the question is associated with the measure and the treatment, receiving an answer to the question, and determining from the answer whether the treatment meets the benchmark of the measure.

In another embodiment, a system may include a processor and a memory component that stores logic that, when executed by the processor, causes the system to receive a plurality of measures associated with a compliance agency, receive patient information regarding a patient, where the patient information includes data related to a treatment for the patient that was performed at a treatment facility, determine whether the treatment is associated with at least one of the plurality of measures, and in response to determining that the treatment is associated with at least one of the plurality of measures, create an association between the patient and the respective measures. In some embodiments, the logic causes the system to determine, from the patient information and the respective measures, a question for determining whether the treatment meets a predetermined benchmark, receive an answer to the question, and provide data related to the answer to the compliance agency.

In yet another embodiment, a non-transitory computer-readable medium may include logic that, when executed by a processor, causes a computing device to receive patient information regarding a patient, where the patient information includes data related to a treatment for the patient that was performed at a treatment facility, determine a question to be provided to a user, where the question is associated with a measure that was defined by a compliance agency, and provide the question for display. In some embodiments, the logic causes the computing device to determine whether the patient information includes an answer to the question for the treatment and, in response to determining that the patient information contains the answer to the question for the treatment, provide the answer for display with the question.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a computing environment providing core measures, according to one or more embodiments shown and described herein;

FIG. 2 depicts a remote computing device for providing core measures, according to one or more embodiments shown and described herein;

FIG. 3 depicts a user interface that may be provided for a user to enter information regarding one or more patient, according to one or more embodiments shown and described herein;

FIG. 4 depicts a user interface for providing measures that are provided to a patient, according to one or more embodiments shown and described herein;

FIG. 5 depicts a user interface for providing details and searching functionality for a patient, according to one or more embodiments shown and described herein;

FIG. 6 depicts a user interface for providing details of treatments provided over a predetermined time, according to one or more embodiments shown and described herein; and

FIG. 7 depicts a flowchart for providing core measures, according to one or more embodiments shown and described herein.

### DETAILED DESCRIPTION

Embodiments disclosed herein provide computer implemented systems and methods for managing core measures specified and published by a compliance service, such as the Joint Commission, CMMS, etc. Accordingly, embodiments described herein may be configured to identify one or more measures to which a patient is assigned. The measures may be defined by the compliance service and may be associated with one or more benchmarks for patient care. Based on the measures determined for a particular patient, the system and/or method may determine questions (e.g., a first question and a different question) to ask a medical professional to determine whether the treatment facility complied with the benchmarks defined by the measures. Based on answers provided, the questions may change to ensure compliance with the one or more benchmarks in the associated measures. Similarly, some embodiments may be configured to automatically populate and/or answer questions, based on information stored about the patient. Some embodiments may make similar determinations and provide similar functionality for at least one additional patient case to provide an overall determination of compliance over a predetermined period of time.

Some embodiments may also be configured to determine a number of patients or patient cases that are in association with a measure that a treatment facility sees over a predetermined time. These embodiments may additionally determine, based on this number, a number of cases that the treatment facility must report to the one or more compliance agencies. Accordingly, an indication may be provided regarding which cases should be reported and thus, automatically determine questions for those cases.

The systems and methods may also be configured to provide patient accounts (with associated documents and medical codes) and use that information to enter core measure fields for a patient account. Viewing and/or editing tools implemented via a web application may be provided via a server or other computing device over a network interface system to determine which core measure sets are likely to be applicable to an account based on incoming patient demographics, account documentation and account medical coding information. The computer engine may also provide and/or populate suggested values for core measure data fields based on analysis of account information. Suggestions may not be confirmed and may be kept distinct from the real value of the measure until a user views the suggestion and manually approves it.

As the computer engine finds candidate accounts for core measures review and data entry, core measures requiring abstraction and data entry may be flagged by the engine as requiring attention and shown on the main selection screen. A treatment facility quality improvement team may include a plurality of members who can easily view outstanding abstraction/data entry tasks within the graphical user interface and take the appropriate action to complete entry of necessary Core Measure Data. Once a core measure has been marked as completed, it may be locked from changes and may be stored for reporting purposes and participation in generating aggregate statistics for upstream systems.

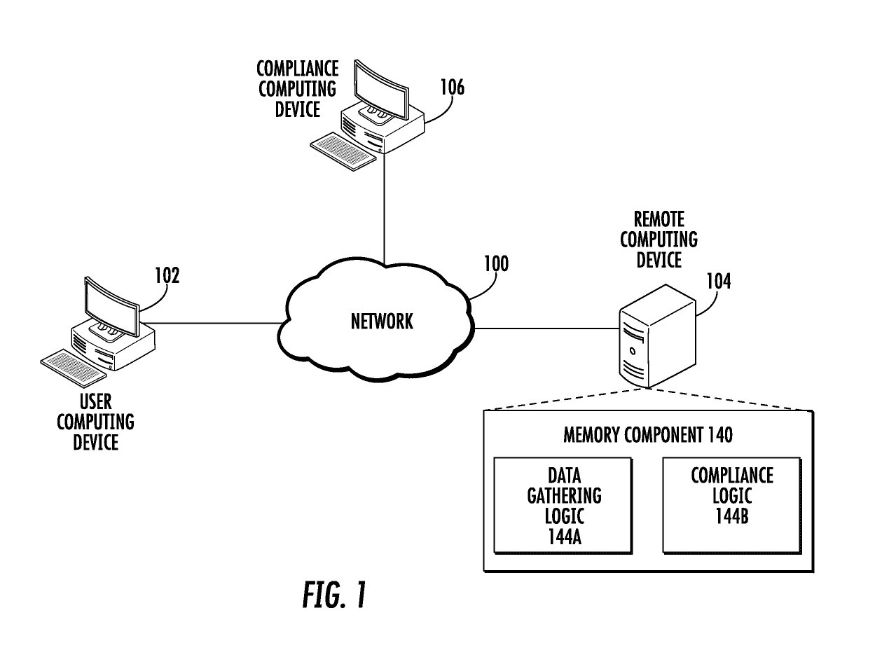

Referring now to the drawings, FIG. 1 depicts a computing environment providing core measures, according to one or more embodiments shown and described herein. As illustrated in FIG. 1, a network 100 may be coupled to a user computing device 102, a remote computing device 104, and a compliance computing device 106. The network 100 may include a wide area network, such as the Internet, a local area network (LAN), a mobile communications network, a public service telephone network (PSTN) and/or other network and may be configured to electronically couple a user computing device 102 and a remote computing device 104.

More specifically, the user computing device 102 may be configured to communicate with the remote computing device 104 to provide the user with one or more user interfaces associated with determining compliance. The remote computing device 104 may include a memory component 140 that stores data gathering logic 144a, compliance logic 144b, and/or other logic and may be configured to provide a web portal to the user computing device 102 and/or the compliance computing device 106. The remote computing device 104 may also receive user input via the user computing device 102 and/or the compliance computing device 106 that identifies tasks taken by treatment facility staff to ensure compliance for a compliance agency.

Additionally, the compliance computing device 106 may reside at a compliance agency and may receive one or more reports from the remote computing device 104 related to tasks performed by a treatment facility, as indicated by the user computing device 102. Accordingly, the compliance computing device 106 may include logic for determining whether a treatment facility has been in compliance over a predetermined assessment period. While in some embodiments, the compliance computing device 106 may receive the reported data via the network 100, some embodiments may include manual or offline entry of data received from the remote computing device 104.

It should be understood that while the user computing device 102 and the compliance computing device 106 are depicted as personal computers and the remote computing device 104 is depicted as a server, these are merely examples. In some embodiments, any type of computing device (e.g. mobile computing device, personal computer, server, etc.) may be utilized for any of these components. Additionally, while each of these computing devices is illustrated in FIG. 1 as a single piece of hardware, this is also an example. In some embodiments, each of the computing devices 102, 104, 106 may represent a plurality of computers, servers, databases, etc.

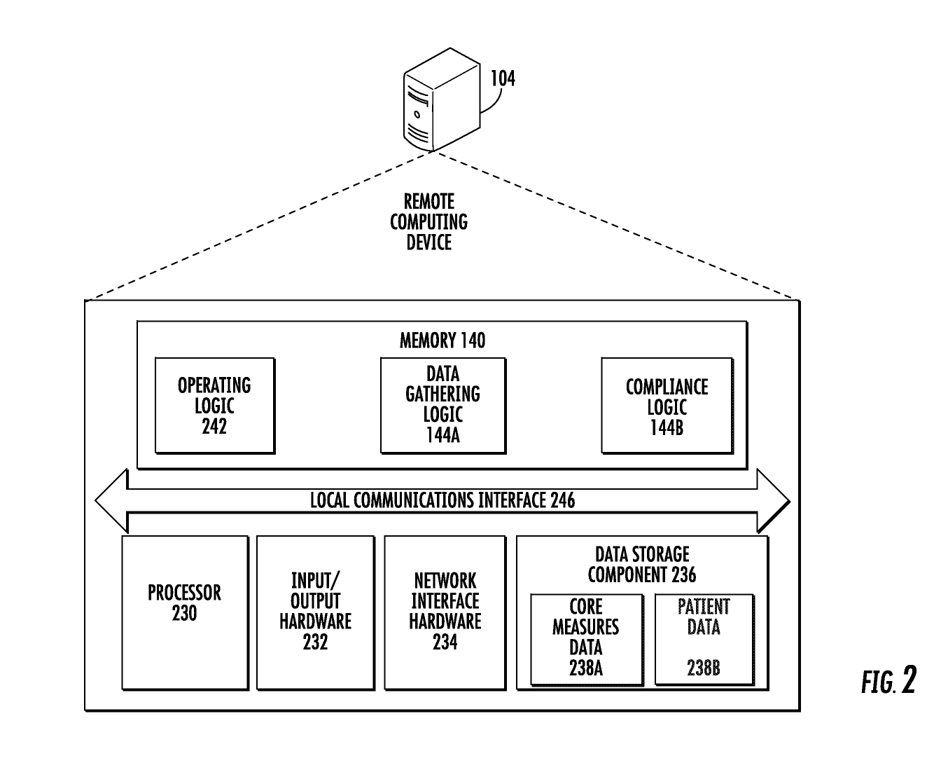

FIG. 2 depicts a remote computing device 104 for providing core measures, according to one or more embodiments shown and described herein. In the illustrated embodiment, the remote computing device 104 includes a processor 230, input/output hardware 232, network interface hardware 234, a data storage component 236 (which stores profile data 238a and content data 238b), and the memory component 140. The memory component 140 may be configured as volatile and/or nonvolatile memory and, as such, may include random access memory (including SRAM, DRAM, and/or other types of RAM), flash memory, registers, compact discs (CD), digital versatile discs (DVD), and/or other types of non-transitory computer-readable mediums. Depending on the particular embodiment, these non-transitory computer-readable mediums may reside within the remote computing device 104 and/or external to the remote computing device 104.

Additionally, the memory component 140 may be configured to store operating logic 242, the data gathering logic 144a, and the compliance logic 144b, each of which may be embodied as a computer program, firmware, and/or hardware, as an example. A local communications interface 246 is also included in FIG. 2 and may be implemented as a bus or other interface to facilitate communication among the components of the remote computing device 104.

The processor 230 may include any processing component operable to receive and execute instructions (such as from the data storage component 236 and/or memory component 140). The input/output hardware 232 may include and/or be configured to interface with a monitor, keyboard, mouse, printer, camera, microphone, speaker, and/or other device for receiving, sending, and/or presenting data. The network interface hardware 234 may include and/or be configured for communicating with any wired or wireless networking hardware, an antenna, a modem, LAN port, wireless fidelity (Wi-Fi) card, WiMax card, mobile communications hardware, and/or other hardware for communicating with other networks and/or devices. From this connection, communication may be facilitated between the remote computing device 104 and other computing devices.

Similarly, it should be understood that the data storage component 236 may reside local to and/or remote from the remote computing device 104 and may be configured to store one or more pieces of data for access by the remote computing device 104 and/or other components. In some embodiments, the data storage component 236 may be located remotely from the remote computing device 104 and thus accessible via the network 100. In some embodiments however, the data storage component 236 may merely be a peripheral device, but external to the remote computing device 104.

Included in the memory component 140 are the operating logic 242, the data gathering logic 144a and the compliance logic 144b. The operating logic 242 may include an operating system and/or other software for managing components of the remote computing device 104. Similarly, the data gathering logic 144a may be configured to cause the remote computing device 104 to determine questions to present to a user for adhering to one or more compliance determinations, as well as receiving responses from the user. Additionally, compliance logic 144b may reside in the memory component 140 and may be configured to cause the processor 230 to determine whether information input by the user indicates that a treatment facility or other institution is adhering to one or more regulations, as well as provide the content to other user computing devices, such as the compliance computing device 106 and/or the user computing device 102.

It should be understood that the components illustrated in FIG. 2 are merely exemplary and are not intended to limit the scope of this disclosure. While the components in FIG. 2 are illustrated as residing within the remote computing device 104, this is merely an example. In some embodiments, one or more of the components may reside external to the remote computing device 104. It should also be understood that, while the remote computing device 104 in FIGS. 1 and 2 is illustrated as a single system, this is also merely an example. In some embodiments, the content providing functionality is implemented separately from the advertisement functionality, which may be implemented with separate hardware, software, and/or firmware.

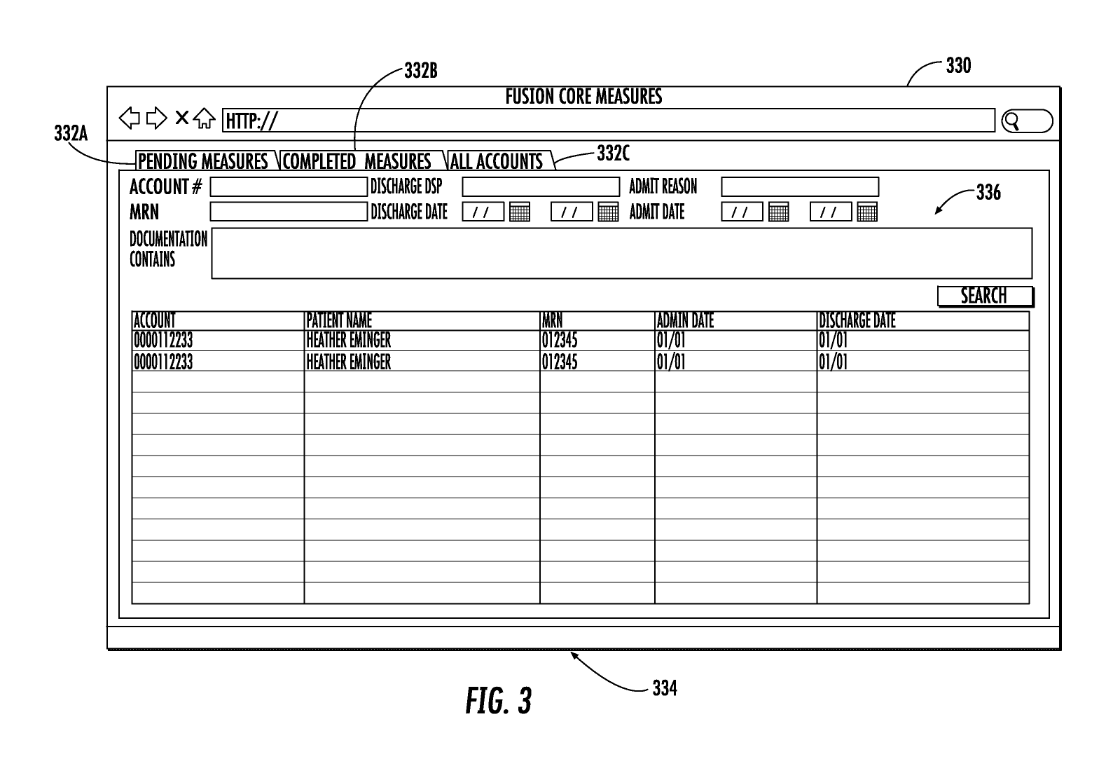

FIG. 3 depicts a user interface 330 that may be provided for a user to enter information regarding one or more patient, according to one or more embodiments shown and described herein. As illustrated, the user interface may provide information related to one or more patients, where the information may be reported to a compliance agency. Specifically, the user interface includes a pending measures tab 332a, a completed measures tab 332b, and an all accounts tab 332c. In response to selection of the pending measures tab 332a, the user (who may be a treatment facility employee, such as a registered nurse, doctor, etc.), the user interface may provide a listing of all pending measures for the treatment facility, division of a treatment facility and/or a plurality of treatment facilities. Specifically, the intake system for a treatment facility may receive patient information related to a plurality of patients who are treated at the treatment facility. The patient information may include biographic information, such as name, gender, address, etc., as well as treatment information, such as time of admittance, time from admittance to treatment, actions taken during treatment, etc.

Additionally, the remote computing device 104 may receive measure data related to a plurality of measures by which the treatment facility must comply. Specifically, a measure may include an identification of a condition for which a patient may be treated at the treatment facility. The measure may relate to a predetermined benchmark by which the treatment facility must meet. As an example, a measure may include treatment for a heart attack, treatment for a broken leg, treatment for a heart transplant, etc. Accordingly, the remote computing device 104 may compare the patient information with the plurality of predetermined measures to determine whether the patent information should be associated with one or more of the measures. If so, the remote computing device 104 identifies the patient information with the one or more measures. As will be understood, each of the compliance agencies may have distinct measures. Accordingly, a patient and/or treatment may apply to one or more measures for each of the compliance agencies.

Referring back to the user interface 330 in FIG. 3, a listing of the pending measures may be provided in the list section 334. The list section 334 may include an account number, a patient name, a medical record number (MRN), an admitted date, and a discharge date. The user may select one or more of the patients to see additional detail on the measure, patient information, etc. Additionally included is a search section, which provides the user with one or more fields for searching a patient, account number, and/or other information.

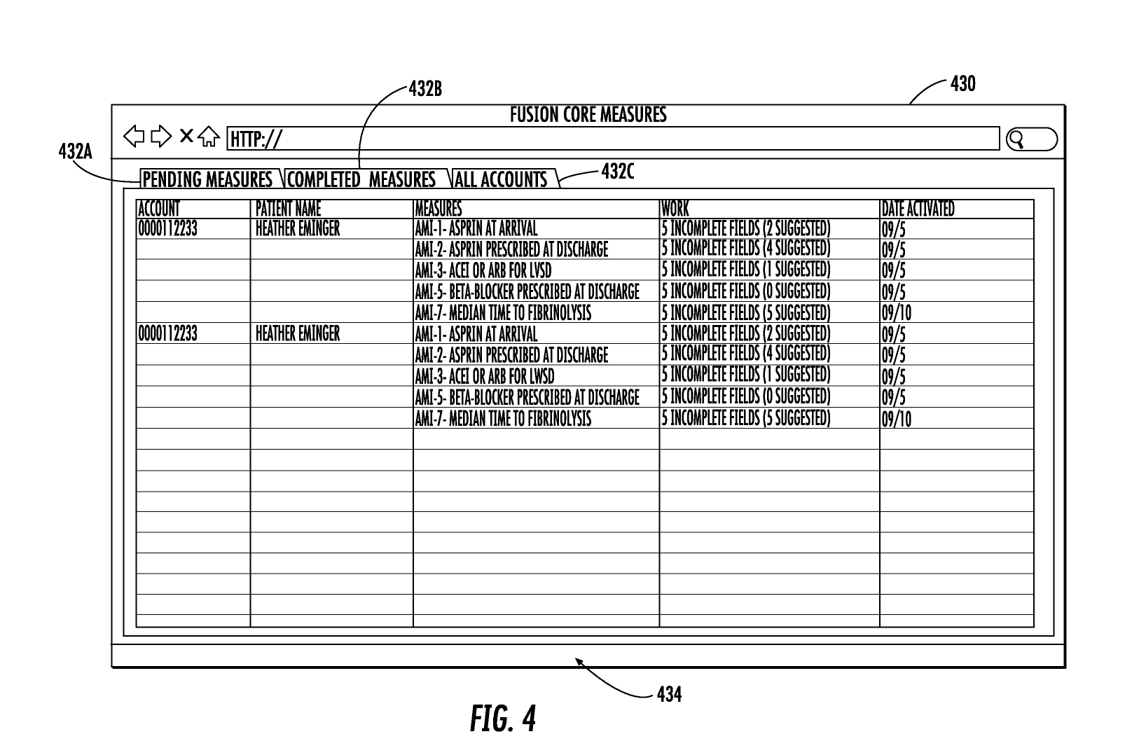

FIG. 4 depicts a user interface 430 for providing measures that are provided to a patient, according to one or more embodiments shown and described herein. In response to selection of an account from FIG. 3, the user interface 430 may be provided. As illustrated, the user interface 430 includes a pending measures tab 432a, a completed measures tab 432b, and an all accounts tab 432c. Also included is a details section 434, which provides detailed information regarding measures that have been determined for a patient. The details section 434 may include an account number, a patient name, a measures listing, a work listing, and a date activated listing. Specifically, the remote computing device 104 may determine that the patient Heather Eminger is associated with five different measures, which are listed in the measures listing. As described in more detail below, the user will be required to answer one or more questions and/or fields associated with treatment of that patient. Accordingly, the work listing identifies the fields that have yet to be completed. The date activated listing provides a date that the account was activated.

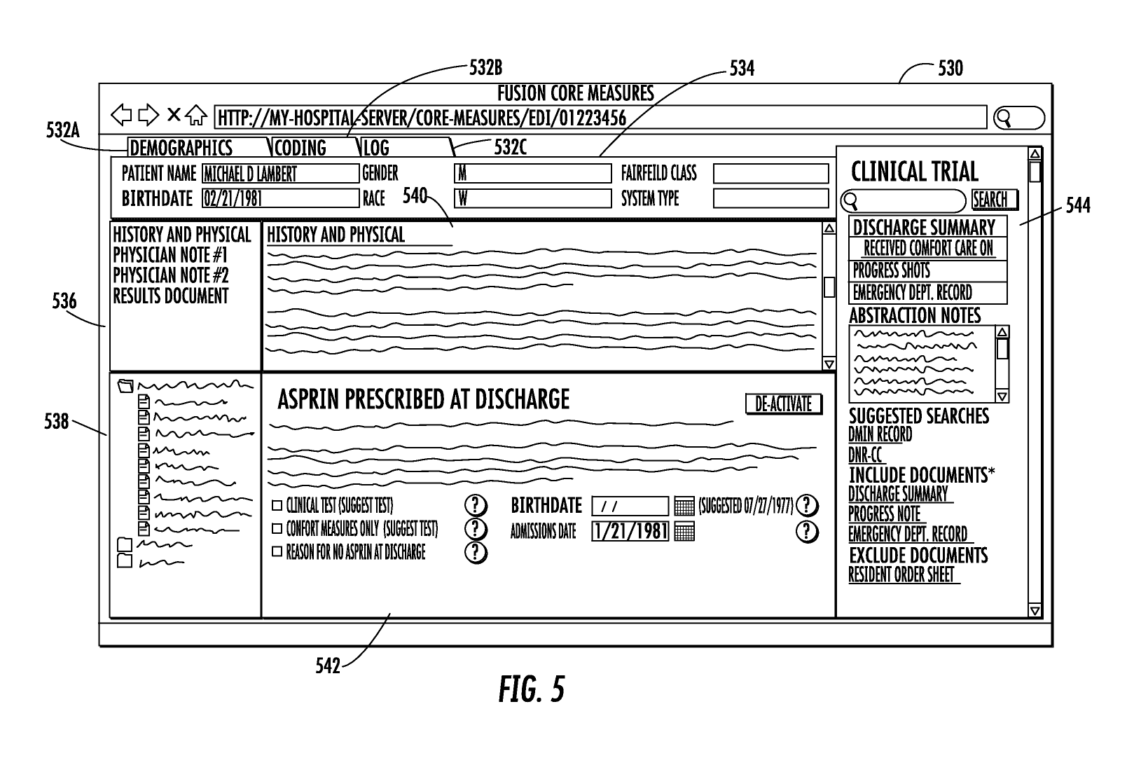

FIG. 5 depicts a user interface 530 for providing details and searching functionality for a patient, according to one or more embodiments shown and described herein. In response to selection of a patient in FIG. 4, the user interface 530 may be provided. As illustrated, the user interface 530 includes a demographics tab 532a, a coding tab 532b, and a log tab 532c. Under the demographics tab 532a is an account information section 534, which includes a patient name field, a gender field, a financial class field, a birth date field, a race field, and a service type field. Under the coding tab 532b, is a listing of codes that are associated with the patient. The log tab 532c includes a list of system messages related to the account and/or activity associated with the account.

Also included is a documentation section 536. The documentation section 536 includes at least one treatment provider note, results documentation, and/or other documentation for the account. As described in more detail below, option may be provided to search terms listed in the documentation section 536 that have changed since last viewed. A core measures section 538 is also provided and includes a hierarchal representation of one or more questions that may be provided to the user for the selected account. As described above, the questions may be determined based on an assessment of the measures to which the patient is associated. Additionally, based on the answers provided to the questions, the listing of questions in the core measures section 538 may change. Active core measures may be highlighted in a different color or other signifier. Editing options may also be provided.

In response to selection of a question from the core measures section 538, a data fields section 542 may be provided. The data fields section 542 may include one or more questions for the patient care, based on the determined measures for that patient. Additionally, fields may be provided for the user to answer the provided question. Depending on the embodiment, the remote computing device 104 and/or the user computing device 102 may determine an answer or suggested answer to a question and automatically populate that field and/or provide a suggestion accordingly. This determination may be made based on stored documents and/or other data associated with the patient.

Also included in the user interface 530 is a research section 544. The research section 544 may provide search functionality to locate documents associated with the patent for populating the associated fields. Also included is an abstraction notes portion of the user to enter and/or view notes for the patient. The remote computing device 104 and/or the user computing device 102 may also provide suggested searches for each question, suggested documents, as well as documents associated with the patient that may be viewed, but not used for answering a question.

Additionally, in response to selection of a field from the data fields section 542, the research section 544 may automatically populate to search documentation and otherwise tailor the information provided in the research section 544 to that particular question and/or field. This provides additional functionality for locating an answer to the provided question.

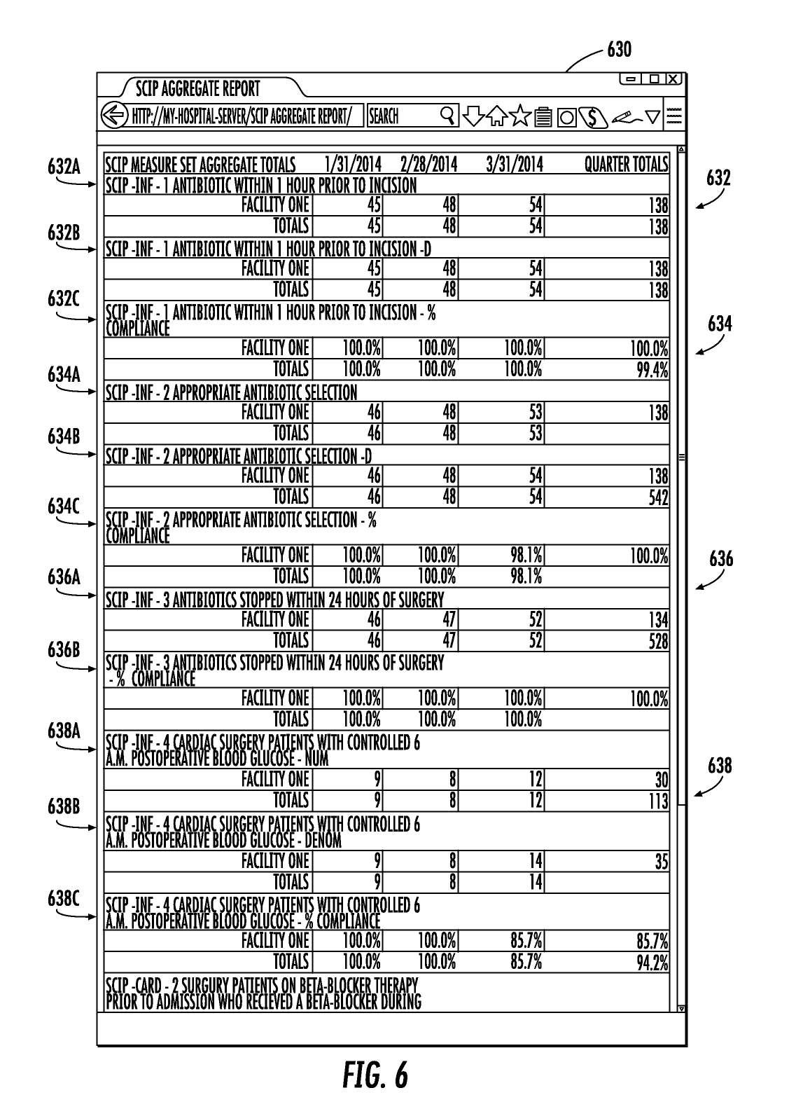

FIG. 6 depicts a user interface 630 for providing details of treatments provided over a predetermined time, according to one or more embodiments shown and described herein. As illustrated, a treatment facility may treat a plurality of patients for one or more measures and that data may be complied and provided in the user interface 630. Accordingly, the user interface 630 of FIG. 6 depicts a plurality of measures 632, 634, 636, 638 and tasks associated with those measures and a number of times that the treatment facility performed the treatment according to the benchmark set forth by the measure. Accordingly, as illustrated in row 632a, the treatment facility provided antibiotic within one our prior to an incision 45 times in January, 48 times in February, 54 times in March according to the first measure 632. As illustrated in row 632b, the treatment facility had the opportunity to implement this treatment 45 times in January, 48 times in February, and 54 times in March. Accordingly, row 632c illustrates that this treatment facility was compliant with the second measure 634 100% of the time during this time period and 99.4% compliance over the entire period of measure. Based on a predetermined benchmark, the treatment facility may or may not be compliant.

Similarly, a second measure 634 is also depicted. The second measure 634 relates to whether the appropriate antibiotic was selected. As illustrated in row 634a, the treatment facility selected the appropriate antibiotic a total of 138 times during the given quarter. In row 634b, the treatment facility was provided with an opportunity to implement this treatment 138 times over the quarter and 536 times over the total period. Thus, in row 634c, the treatment facility practiced this treatment 100% over the quarter and 98.9% over the total period. With regard to the third measure 636, in row 636a, the facility stopped antibiotics within 24 hours of surgery 134 times over this quarter and 528 times over the entire period of measure. In row 636b, the treatment facility implemented this treatment 100% of the time over the quarter and 98.7% of the time over the entire period. While the facility met this benchmark over this quarter, the treatment facility only met this requirement 98.7% over the entire period of measure. In the fourth measure 638, row 638a indicates that the treatment facility treated cardiac surgery patients with controlled 6:00 AM postoperative blood glucose 30 times. In row 638b, the treatment facility had opportunities 35 times. In row 638c, this indicates an 85.7% compliance rate over the quarter. Based on a determined benchmark for each of the measures, the remote computing device 104 may comply with the measure.

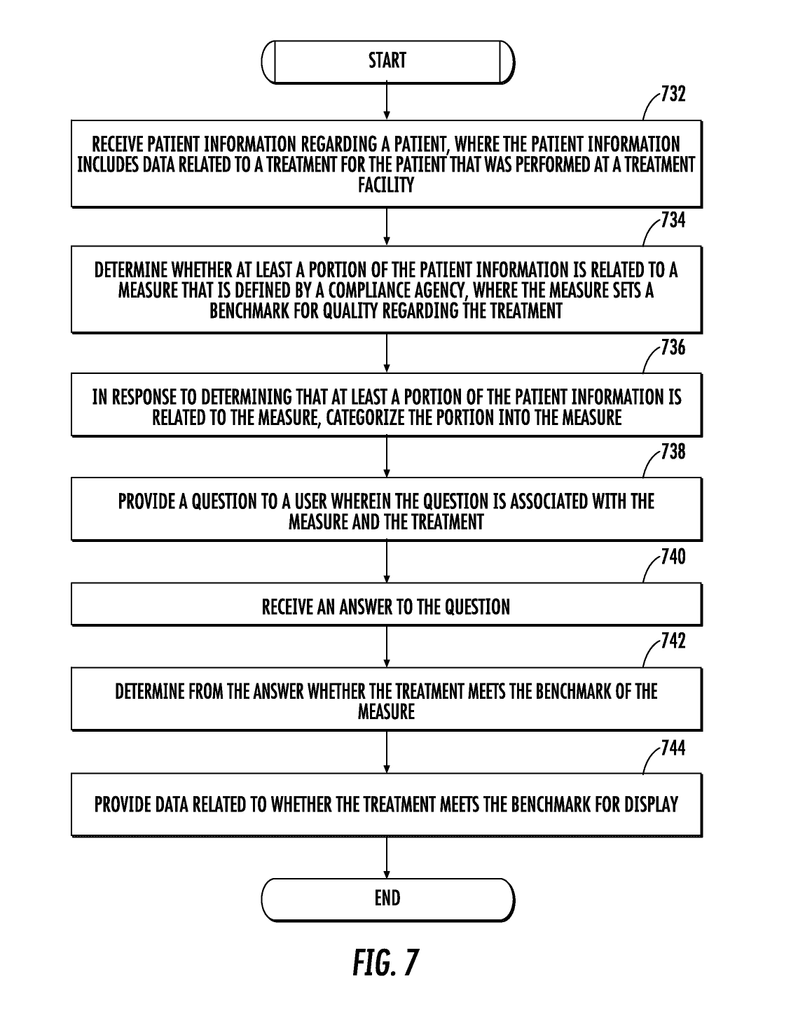

FIG. 7 depicts a flowchart for providing core measures, according to one or more embodiments shown and described herein. As illustrated in block 732, patient information regarding a patient may be received, where the patient information includes data related to a treatment for the patient that was performed at a treatment facility. In block 734, a determination may be made regarding whether at least a portion of the patient information is related to a measure that is defined by a compliance agency, where the measure sets a benchmark for quality regarding the treatment. In block 736, in response to determining that at least a portion of the patient information is related to the measure, categorize the portion into the measure. In block 738, a question may be provided to a user, where the question is associated with the measure and the treatment. In block 740, an answer to the question may be received. In block 742, a determination may be made from the answer regarding whether the treatment meets the benchmark of the measure. In block 744, data related to whether the treatment meets the benchmark may be provided for display.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for providing core measures, comprising:
receiving, by a computing device, patient information regarding a patient, wherein the patient information includes data related to a treatment for the patient that was performed at a treatment facility;
determining, by the computing device, whether at least a portion of the patient information is related to a measure that is defined by a compliance agency, wherein the measure establishes a benchmark for quality regarding the treatment;
in response to determining that a least a portion of the patient information is related to the measure, categorizing, by the computing device, the portion into the measure;
providing, by the computing device, a question to a user wherein the question is associated with the measure and the treatment;
receiving, by the computing device, an answer to the question;
determining, by the computing device, from the answer whether the treatment meets the benchmark of the measure; and
providing, by the computing device, data related to whether the treatment meets the benchmark for display.

2. The method of claim 1, further comprising:
determining whether the patient information includes the answer to the question; and
in response to determining that the patient information includes the answer to the question, providing the answer with the question.

3. The method of claim 1, further comprising providing an option to access documents from the patient information for answering the question.

4. The method of claim 1, further comprising sending the data related to whether the treatment meets the benchmark to the compliance agency.

5. The method of claim 1, further comprising:
determining a different question to determine compliance with the measure, based on the answer;
providing the different question to the user; and
receiving a response to the different question.

6. The method of claim 1, further comprising
determining a number of patient cases to report to the compliance agency over a predetermined period of time;
determining whether the treatment facility prepared the number of patient cases to be reported the compliance agency over the predetermined period of time; and
in response to determining that the treatment facility has not prepared the number of patient cases to be reported to the compliance agency, providing an indication to the user to prepare an additional patient case.

7. The method of claim 1, further comprising:
determining a suggested answer to the question; and
providing the suggested answer to the user as an option for accepting as the answer.

8. A system for providing core measure, comprising:
a processor; and
a memory component that stores logic that, when executed by the processor, causes the system to perform at least the following:
receive a plurality of measures associated with a compliance agency;
receive patient information regarding a patient, wherein the patient information includes data related to a treatment for the patient that was performed at a treatment facility;
determine whether the treatment is associated with at least one of the plurality of measures;
in response to determining that the treatment is associated with at least one of the plurality of measures, create an association between the patient and the respective measures;
determine, from the patient information and the respective measures, a question for determining whether the treatment meets a predetermined benchmark;
receive an answer to the question; and
provide data related to the answer to the compliance agency.

9. The system of claim 8, wherein the logic further causes the system to categorize at least a portion of the patient information into at least one of the respective measures that is defined by the compliance agency.

10. The system of claim 8, wherein the logic further causes the system to provide an option to access documents from the patient information for answering the question.

11. The system of claim 8, wherein the logic further causes the system to determine whether the treatment facility complies with at least one of the respective measures.

12. The system of claim 8, wherein the logic further causes the system to perform at least the following:
determine a different question to determine compliance with at least one of the respective measures, based on the answer;
provide the different question to a user; and
receive a response to the different question.

13. The system of claim 8, wherein the logic further causes the system to perform at least the following:
determine a number of patient cases to report to the compliance agency over a predetermined period of time;
determine whether the treatment facility prepared the number of patient cases to be reported the compliance agency over the predetermined period of time; and
in response to determining that the treatment facility has not prepared the number of patient cases to be reported to the compliance agency, provide an indication to a user to prepare an additional patient case.

14. The system of claim 8, wherein the logic further causes the system to perform at least the following:
determine a suggested answer to the question; and
provide the suggested answer to a user as an option for accepting as the answer.

15. A non-transitory computer-readable medium comprising logic that, when executed by a processor, causes a computing device to perform at least the following:
receive patient information regarding a patient, wherein the patient information includes data related to a treatment for the patient that was performed at a treatment facility;
determine a question to be provided to a user, wherein the question is associated with a measure that was defined by a compliance agency;
providing the question for display;
determine whether the patient information includes an answer to the question for the treatment; and
in response to determining that the patient information contains the answer to the question for the treatment, provide the answer for display with the question.

16. The non-transitory computer-readable medium of claim 15, wherein the logic further causes the computing device to provide an option to access documents from the patient information for answering the question.

17. The non-transitory computer-readable medium of claim 15, wherein the logic further causes the computing device to send the data related to whether the treatment meets a benchmark to the compliance agency.

18. The non-transitory computer-readable medium of claim 15, wherein the logic further causes the computing device to perform at least the following:
determine a different question to determine compliance with the measure, based on the answer;
provide the different question to the user; and
receive a response to the different question.

19. The non-transitory computer-readable medium of claim 15, wherein the logic further causes the computing device to perform at least the following:
determine a number of patient cases to report to the compliance agency over a predetermined period of time;
determine whether the treatment facility prepared the number of patient cases to be reported the compliance agency over the predetermined period of time; and
in response to determining that the treatment facility has not prepared the number of patient cases to be reported to the compliance agency, provide an indication to the user to prepare an additional patient case.

20. The non-transitory computer-readable medium of claim 15, wherein the logic further causes the computing device to perform at least the following:
determine a suggested answer to the question; and
provide the suggested answer to the user as an option for accepting as the answer.
